(19) United States
(12) Patent Application Publication
(10) Pub. No.: US 2025/0128349 A1
(43) Pub. Date: Apr. 24, 2025

(54) DOUBLE-MIRROR FOCUSING INSIDE-BEAM POWDER-FEEDING LASER-CLADDING DEVICE

(71) Applicants: China Yangtze Power Co.,Ltd., Wuhan (CN); Wuhan Digital Design and Manufacturing Innovation Center Co.,Ltd., Wuhan (CN)

(72) Inventors: Hui Liu, Wuhan (CN); Tao Wu, Wuhan (CN); Zaiming Geng, Wuhan (CN); Ming Ma, Wuhan (CN); Yun Yu, Wuhan (CN); Jian Deng, Wuhan (CN); Jie Yang, Wuhan (CN); Xiangli Kong, Wuhan (CN); Ziran Feng, Wuhan (CN); Chong Li, Wuhan (CN)

(21) Appl. No.: 18/892,357

(22) Filed: Sep. 21, 2024

(30) Foreign Application Priority Data
Oct. 19, 2023 (CN) 2023113591244

(51) Int. Cl. B23K 26/06; B23K 26/34

(52) U.S. Cl. CPC B23K 26/0643; B23K 26/0648; B23K 26/34

(57) ABSTRACT

A double-mirror focusing inside-beam powder-feeding laser-cladding device includes: first and second reflection beam splitters, a focusing lens, a vertical piping powder feeding device, and a collimated lens group. The first reflection beam splitter is disposed at a side of the collimated lens group; the second reflection beam splitter is disposed outside the first reflection beam splitter; the focusing lens is disposed at a side of the second reflection beam splitter facing away the collimated lens group; and the vertical piping powder feeding device is disposed at a side of the first reflection beam splitter facing away the collimated lens group. When the device is in use, a collimated beam is formed through the collimated lens group, and then reflected by the first and second reflection beam splitters to form an annular laser beam that can be focused by the focusing lens to form a light spot.

### CROSS-REFERENCE TO RELATED APPLICATION

This application claims priority to a Chinese patent application No. 202311359124.4, filed to China National Intellectual Property Administration (CNIPA) on Oct. 19, 2023, which is herein incorporated by reference in its entirety.

### TECHNICAL FIELD

The disclosure relates to the technical field of laser cladding, and more particularly to a double-mirror focusing inside-beam powder-feeding laser-cladding device.

### BACKGROUND

At present, the inside-beam powder-feeding laser-cladding technology mainly forms a light spot by reflecting and focusing on a parabolic surface after light reflection and beam splitting. However, in practical production and application, problems such as unstable energy of the light spot and poor adaptability are prone to occur. In the related art, a parabolic reflection focusing form is used, but its sensitivity to optical axis misalignment is extremely high, which makes it easy to generate coma, and astigmatism caused by fine misalignment will greatly reduce light intensity of the focused light spot. Therefore, in practical use, the effect of laser processing generated by the parabolic surface reflection is not ideal.

Chinese patent document CN113005445B discloses a device for cladding different hollow or solid light spots by light path offset focus and using method, and provides a variable optical path focusing technology. Namely, a focal length of a collimating mirror is changed through movement or a relative position between an annular conical straight surface reflector and a conical straight surface reflector is changed through movement from a collimating optical path, a beam expanding optical path, and a focusing optical path, so that after a focusing beam is reflected by the conical straight surface reflector and the annular conical straight surface reflector, a formed hollow conical beam is intersected before focusing, and a focus thereof deviates from an optical axis and forms a focus circle. Different solid light spots or annular light spots with a small duty ratio are obtained on different optical axis cross sections of the intersected beam, the problem that the central light energy is insufficient due to the fact that the duty ratio of hollow light spots in an original non-offset focusing light path is too large can be solved, and cladding forming with a wide melting channel is achieved. However, the above structure is focused by the reflections of the conical straight surface reflector and the annular conical straight surface reflector, the focusing intensity is poor, and a larger functional laser is required to complete laser cladding processing.

### SUMMARY

A technical problem to be solved by the present disclosure is the problems existing in the related art need to be solved, and a double-mirror focusing inside-beam powder-feeding laser-cladding device is provided. The double-mirror focusing inside-beam powder-feeding laser-cladding device is capable of forming an annular laser beam, which is reflected by a first reflection beam splitter and a second reflection beam splitter, and then the annular laser beam is irradiated and focused by a focusing lens to form a light spot, so that an intensity of the focused light spot is high.

In order to achieve the above technical features, an objective of the present disclosure is achieved as follows. The double-mirror focusing inside-beam powder-feeding laser-cladding device includes: a first reflection beam splitter, a second reflection beam splitter, a focusing lens, a vertical piping powder feeding device, and a collimated lens group. The first reflection beam splitter is disposed at a side of the collimated lens group; the second reflection beam splitter is disposed outside the first reflection beam splitter; the focusing lens is disposed at a side of the second reflection beam splitter facing away from the collimated lens group; and the vertical piping powder feeding device is disposed at a side of the first reflection beam splitter facing away from the collimated lens group. When the double-mirror focusing inside-beam powder-feeding laser-cladding device is in use, a laser beam is formed into a collimated beam through the collimated lens group, the collimated beam is then reflected by the first reflection beam splitter and the second reflection beam splitter, and is offset outwards relative to a central axis to form an annular laser beam, and the annular laser beam is irradiated and focused by the focusing lens to form a light spot.

The double-mirror focusing inside-beam powder-feeding laser-cladding device further includes: a laser output device; and the laser output device is disposed at a side of the collimated lens group facing away from the first reflection beam splitter, and the laser output device is configured to connect to a transmission fiber to output the laser beam.

The double-mirror focusing inside-beam powder-feeding laser-cladding device further includes: a protective mirror; and the protective mirror is disposed at a side of the focusing lens facing away from the second reflection beam splitter.

Specifically, the protective mirror is of an annular structure.

Specifically, the first reflection beam splitter and the second reflection beam splitter are configured to shift the collimated beam outwards in parallel or at an angle relative to the central axis.

Specifically, a diameter of the focusing lens is greater than that of a cross-sectional circle of the second reflection beam splitter.

Specifically, the focusing lens is of an annular structure.

Specifically, the first reflection beam splitter and/or the second reflection beam splitter are capable of moving along the central axis, thereby adjusting a diameter of the light spot.

Specifically, a plane mirror is disposed between the second reflection beam splitter and the focusing lens, and the plane mirror is capable of reflecting the annular laser beam with a deflection angle of 0-90 degrees, thereby to be focused by the focusing lens.

A light-spot adjustment device is installed at a bottom of the first reflection beam splitter, and the first reflection beam splitter is capable of adjustably moving along the central axis through the light-spot adjustment device; the light-spot adjustment device includes: a base, a lifting base, and wedges, an upper side surface of the base is provided with a concave V-shaped surface, a lower side surface of the lifting base is provided with a convex V-shaped surface, and the lifting base is disposed on the base; each of two opposite sides of the base defines at least two sliding grooves, a threaded hole is defined on the base and located between adjacent two of the at least two sliding grooves, upper sides of the at least two sliding grooves are open, and each of the at least two sliding grooves is provided with a corresponding one of the wedges therein, an upper inclined surface of each of the wedges is disposed corresponding to the lower side surface of the lifting base, a connecting plate is disposed between the adjacent two wedges on each side of the base, a threaded end of a bolt penetrates through the connecting plate and is in threaded connection with the threaded hole, a side of the base facing towards the lifting base and a side of the lifting base facing towards the base symmetrically define multiple pairs of blind holes respectively, the multiple pairs of blind holes are provided with springs therein, upper ends of the springs are fixedly connected to the lifting base, and lower ends of the springs are fixedly connected to the base; and the first reflection beam splitter is disposed on an upper side surface of the lifting base.

1. The laser beam is formed into the collimated beam through the collimated lens group, the collimated beam is secondarily reflected by the first reflection beam splitter and the second reflection beam splitter, the collimated light beam is further offset outwards relative to the central axis to form the annular laser beam, and then the annular laser beam is irradiated and focused by the focusing lens to form the light spot. The first reflection beam splitter and the second reflection beam splitter are used to reflect the collimated beam to form the annular laser beam, and then the annular laser beam is irradiated and focused by the focusing lens to form the light spot, which generates the focused light spot with a high intensity.

2. The present disclosure realizes the inside-beam powder-feeding by coupling the center power-feeding with the annular hollow laser beam. Compared with the parabolic reflection focusing method, the present disclosure greatly reduces the aberration of the laser optical system and reduces the sensitivity to optical axis misalignment. Meanwhile, the present disclosure has low processing difficulty and relatively low price. And the working focal length of the double-mirror focusing inside-beam powder-feeding laser-cladding device can be adjusted by replacing the focusing lens, which does not affect the size of the reserved space for inside-beam powder-feeding.

3. The reflection beam splitter and/or the second reflection beam splitter can move along the central axis, thereby adjusting the diameter of the light spot.

4. The plane mirror is arranged between the second reflection beam splitter and the focusing lens, so that the annular laser beam is reflected by the plane mirror with the deflection angle of 0-90 degrees and then is focused through the focusing lens, which is convenient to apply to a narrow space.

### BRIEF DESCRIPTION OF DRAWINGS

FIG. 1 illustrates a schematic structural diagram of a double-mirror focusing inside-beam powder-feeding laser-cladding device according to the present disclosure.

FIG. 2 illustrates a schematic structural diagram of a light-spot adjustment device adjustment device according to the present disclosure from a top view.

FIG. 3 illustrates a schematic structural diagram of the light-spot adjustment device adjustment device without installing a wedge and a bolt according to the present disclosure from a side view.

Description of reference signs are as follows:

1-first reflection beam splitter;

2-second reflection beam splitter;

3-focusing lens;

4-protective mirror;

5-vertical piping powder feeding device;

6-collimated lens group;

7-laser output device;

8-light-spot adjustment device; 81-base; 811-sliding groove; 812-threaded hole;

82-lifting base; 83-wedge; 84-bolt; 85-spring; 86-connecting plate; 87-blind hole;

9-central axis;

10-light spot;

11-laser beam; and

12-plane mirror.

### DETAILED DESCRIPTION OF EMBODIMENTS

The embodiments of the present disclosure are further described below with reference to the attached drawings.

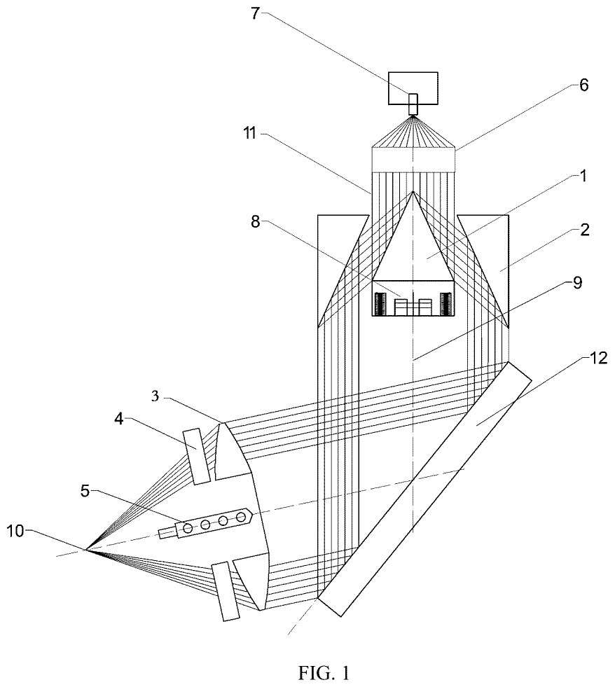

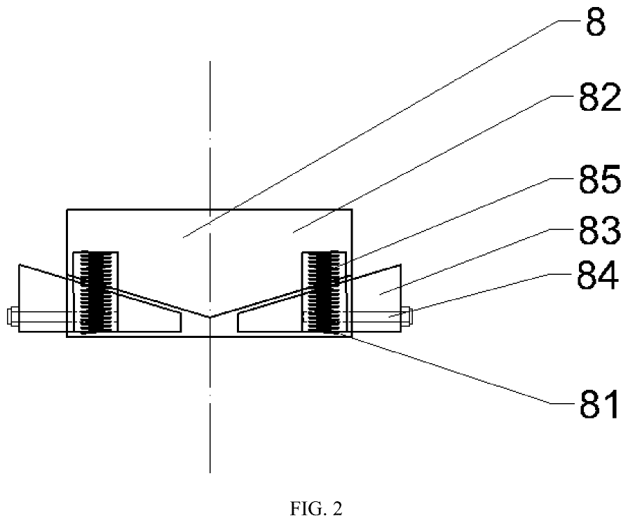

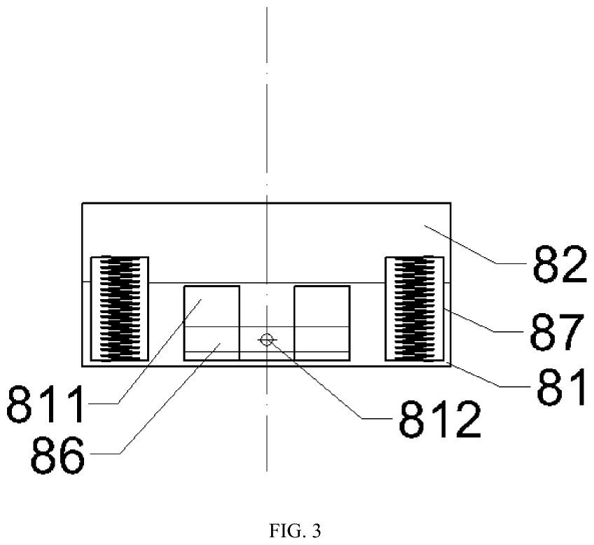

With reference to FIGS. 1-3, a double-mirror focusing inside-beam powder-feeding laser-cladding device includes: a first reflection beam splitter 1, a second reflection beam splitter 2, a focusing lens 3, a vertical piping powder feeding device 5, and a collimated lens group 6. Specifically, the first reflection beam splitter 1 is disposed at a side of the collimated lens group 6; the second reflection beam splitter 2 is disposed outside the first reflection beam splitter 1; the focusing lens 3 is disposed at a side of the second reflection beam splitter 2 facing away from the collimated lens group 6; and the vertical piping powder feeding device 5 is disposed at a side of the first reflection beam splitter 1 facing away from the collimated lens group 6. Moreover, when the double-mirror focusing inside-beam powder-feeding laser-cladding device is in use, a laser beam 11 is formed into a collimated beam through the collimated lens group 6, the collimated beam is then reflected by the first reflection beam splitter 1 and the second reflection beam splitter 2, and is offset outwards relative to a central axis 9 to form an annular laser beam, and then the annular laser beam is irradiated and focused by the focusing lens 3 to form a light spot 10. Specifically, the first reflection beam splitter 1 and the second reflection beam splitter 2 are used to reflect the collimated beam to form the annular laser beam, and then the annular laser beam is irradiated and focused by the focusing lens 3 to form the light spot 10, which generates the focused light spot with a high intensity.

Specifically, the first reflection beam splitter 1 can adopt a conical structure or a multilateral cone structure.

Specifically, the second reflection beam splitter 2 can be of a circular ring structure, or a multilateral structure that is matched with the multilateral cone structure of the first reflection beam splitter 1.

The double-mirror focusing inside-beam powder-feeding laser-cladding device further includes: a laser output device 7 disposed at a side of the collimated lens group 6 facing away from the reflection beam splitter 1, and the laser output device 7 is configured to connect to a transmission fiber to output the laser beam 11.

The double-mirror focusing inside-beam powder-feeding laser-cladding device further includes: a protective mirror 4, and the protective mirror 4 is disposed at a side of the focusing lens 3 facing away from the second reflection beam splitter 2. The protective mirror 4 is configured to protect the first reflection beam splitter 1, the second reflection beam splitter 2, the focusing lens 3, and the collimated lens group 6.

In an illustrated embodiment, the protective mirror 4 is of an annular structure. Certainly, the protective mirror 4 can also be of a spherical structure.

In actual use, the first reflection beam splitter 1 and the second reflection beam splitter 2 are configured to shift the collimated beam outwards in parallel or shift the collimated beam at an angle relative to the central axis 9. Specifically, when side surfaces of the first reflection beam splitter 1 and the second reflection beam splitter 2 that cooperate with each other are disposed parallel to each other, the collimated beam is shifted outward in parallel relative to the central axis 9; and when the side surfaces of the first reflection beam splitter 1 and the second reflection beam splitter 2 that cooperate with each other form an included angle, the collimated beam is shifted with the certain angle relative to the central axis 9.

Specifically, a diameter of the focusing lens 3 is greater than that of a cross-sectional circle of the second reflection beam splitter 2.

In an illustrated embodiment, the focusing lens 3 is of an annular structure, which facilitates the installation of the vertical piping powder feeding device 5.

In order to facilitate adjusting the diameter of the light spot 10 as required, the first reflection beam splitter 1 and/or the second reflection beam splitter 2 are capable of moving along the central axis 9, thereby adjusting the diameter of the light spot 10. According to a calculation formula for the diameter of the light spot 10 of different beam types, it can be known that there is an approximate linear relationship between the diameter of the collimated beam and the diameter of the light spot, so that the diameter of the light spot can be adjusted by adjusting positions of the first reflection beam splitter 1 and the second reflection beam splitter 2 relative to their each other.

In order to make the double-mirror focusing inside-beam powder-feeding laser-cladding device adapt to the field working environment and make it convenient to apply to the narrow space, the plane mirror 12 is disposed between the second reflection beam splitter 2 and the focusing lens 3, so that the annular laser beam is reflected by the plane mirror 12 with the deflection angle of 0-90 degrees, thereby to be focused by the focusing lens 3.

In an illustrated embodiment, a light-spot adjustment device 8 is installed at a bottom of the first reflection beam splitter 1, and the first reflection beam splitter 1 can adjustably move along the central axis 9 through the light-spot adjustment device 8. The light-spot adjustment device includes: a base 81, a lifting base 82, and wedges 83. An upper side of the base 81 is provided with a concave V-shaped surface, a lower side surface of the lifting base 82 is provided with a convex V-shaped surface, and the lifting base 82 is disposed on the base 81. Each of two opposite sides of the base 81 defines at least two sliding grooves 811, a threaded hole 812 is defined on the base 81 and disposed between adjacent two of the at least two sliding grooves 811, upper surfaces of the at least two sliding grooves 811 are open, and each of the at least two sliding grooves 811 is provided with a corresponding one of the wedges 83 therein. Moreover, an upper inclined surface of each of the wedges 83 is disposed corresponding to the lower side surface of the lifting base 82, a connecting plate 86 is disposed between the adjacent two wedges 83 on each side of the base 81, a threaded end of a bolt 84 penetrates through the connecting plate 86 and is in threaded connection with the threaded hole 812, a side of the base 81 facing towards the lifting base and a side of the lifting base 82 facing towards the base 81 symmetrically define multiple pairs of blind holes 87 respectively, the multiple pairs of blind holes 87 are provided with springs 85 therein, upper ends of the springs 85 are fixedly connected with the lifting base 82, and lower ends of the springs 85 are fixedly connected to the base 81. Furthermore, the first reflection beam splitter 1 is disposed on an upper side face of the lifting base 82. By symmetrically rotating the bolts 84 disposed at the two opposite sides of the base 81, the wedges 83 are pushed upwards, and then the wedges 83 pushes the lifting base 82 to rise, thereby driving the first reflection beam splitter 1 to move upwards. When the bolts 84 disposed at the two opposite sides of the base 81 are rotated reversely, the wedges 83 are not limited by the bolts 84, and under the action of the springs 85, the wedges 83 are pressed downwards, and then the wedges 83 move outwards, and the lifting base 82 thereby descends to drive the first reflection beam splitter 1 to move downwards.

Certainly, the first reflection beam splitter 1 or the second reflection beam splitter 2 can also be driven by a servo slide table.

What is claimed is:

1. A double-mirror focusing inside-beam powder-feeding laser-cladding device, comprising: a first reflection beam splitter (1), a second reflection beam splitter (2), a focusing lens (3), a vertical piping powder feeding device (5), and a collimated lens group (6);
wherein the first reflection beam splitter (1) is disposed at a side of the collimated lens group (6); the second reflection beam splitter (2) is disposed outside the first reflection beam splitter (1); the focusing lens (3) is disposed at a side of the second reflection beam splitter (2) facing away from the collimated lens group (6); and the vertical piping powder feeding device (5) is disposed at a side of the first reflection beam splitter (1) facing away from the collimated lens group (6); and
wherein when the double-mirror focusing inside-beam powder-feeding laser-cladding device is in use, a laser beam (11) is formed into a collimated beam through the collimated lens group (6), the collimated beam is then reflected by the first reflection beam splitter (1) and the second reflection beam splitter (2), and is offset outwards relative to a central axis (9) to form an annular laser beam, and the annular laser beam is irradiated and focused by the focusing lens (3) to form a light spot (10).

2. The double-mirror focusing inside-beam powder-feeding laser-cladding device according to claim 1, further comprising: a laser output device (7), wherein the laser output device (7) is disposed at a side of the collimated lens group (6) facing away from the first reflection beam splitter (1), and the laser output device (7) is configured to connect to a transmission fiber to output the laser beam (11).

3. The double-mirror focusing inside-beam powder-feeding laser-cladding device according to claim 1, further comprising: a protective mirror (4), wherein the protective mirror (4) is disposed at a side of the focusing lens (3) facing away from the second reflection beam splitter (2).

4. The double-mirror focusing inside-beam powder-feeding laser-cladding device according to claim 3, wherein the protective mirror (4) is of an annular structure.

5. The double-mirror focusing inside-beam powder-feeding laser-cladding device according to claim 1, wherein the first reflection beam splitter (1) and the second reflection beam splitter (2) are configured to shift the collimated beam outwards in parallel or at an angle relative to the central axis (9).

6. The double-mirror focusing inside-beam powder-feeding laser-cladding device according to claim 1, wherein a diameter of the focusing lens (3) is greater than a diameter of a cross-sectional circle of the second reflection beam splitter (2).

7. The double-mirror focusing inside-beam powder-feeding laser-cladding device according to claim 1, wherein the focusing lens (3) is of an annular structure.

8. The double-mirror focusing inside-beam powder-feeding laser-cladding device according to claim 1, wherein the first reflection beam splitter (1) is capable of moving relative to the second reflection beam splitter (2) along the central axis (9), thereby adjusting a diameter of the light spot (10).

9. The double-mirror focusing inside-beam powder-feeding laser-cladding device according to claim 1, wherein the second reflection beam splitter (2) is capable of moving relative to the first reflection beam splitter (1) along the central axis (9), thereby adjusting a diameter of the light spot (10).

10. The double-mirror focusing inside-beam powder-feeding laser-cladding device according to claim 1, wherein the first reflection beam splitter (1) and the second reflection beam splitter (2) are capable of moving relative to each other along the central axis (9), thereby adjusting a diameter of the light spot (10).

11. The double-mirror focusing inside-beam powder-feeding laser-cladding device according to claim 1, wherein a plane mirror (12) is disposed between the second reflection beam splitter (2) and the focusing lens (3), and the plane mirror (12) is capable of reflecting the annular laser beam with a deflection angle of 0-90 degrees, thereby to be focused by the focusing lens (3).

12. The double-mirror focusing inside-beam powder-feeding laser-cladding device according to claim 8, wherein a light-spot adjustment device (8) is installed at a bottom of the first reflection beam splitter (1), and the first reflection beam splitter (1) is capable of adjustably moving along the central axis (9) through the light-spot adjustment device (8);
wherein the light-spot adjustment device (8) comprises: a base (81), a lifting base (82), and wedges (83), an upper side surface of the base (81) is provided with a concave V-shaped surface, a lower side surface of the lifting base (82) is provided with a convex V-shaped surface, and the lifting base (82) is disposed on the base (81);
wherein each of two opposite sides of the base (81) defines at least two sliding grooves (811), a threaded hole (812) is defined on the base (81) and located between adjacent two of the at least two sliding grooves (811), upper sides of the at least two sliding grooves (811) are open, and each of the at least two sliding grooves (811) is provided with a corresponding one of the wedges (83) therein, an upper inclined surface of each of the wedges (83) is disposed corresponding to the lower side surface of the lifting base (82), a connecting plate (86) is disposed between the adjacent two wedges (83) on each side of the base (81), a threaded end of a bolt (84) penetrates through the connecting plate (86) and is in threaded connection with the threaded hole (812), a side of the base (81) facing towards the lifting base and a side of the lifting base (82) facing towards the base (81) symmetrically define a plurality of pairs of blind holes (87) respectively, the plurality of pairs of blind holes (87) are provided with springs (85) therein, upper ends of the springs (85) are fixedly connected to the lifting base (82), and lower ends of the springs (85) are fixedly connected to the base (81); and
wherein the first reflection beam splitter (1) is disposed on an upper side surface of the lifting base (82).

13. A double-mirror focusing inside-beam powder-feeding laser-cladding device, comprising:
a laser output device (7), a collimated lens group (6), a first reflection beam splitter (1), a light-spot adjustment device (8), and a vertical piping powder feeding device (5), which are sequentially arranged along a central axis (9) in that order;
a second reflection beam splitter (2), disposed at two sides of the first reflection beam splitter (1) and disposed reversely relative to the first reflection beam splitter (1); and
a focusing lens (3), disposed at two sides of the vertical piping powder feeding device (5) and disposed at a side of the light-spot adjustment device (8) facing away from the first reflection beam splitter (1);
wherein the laser output device (7) is configured to output a laser beam (11), the collimated lens group (6) is configured to output a collimated beam based on the laser beam (11), the first reflection beam splitter (1) and the second reflection beam splitter (2) are configured to reflect the collimated beam to form an annular laser beam relative to the central axis (9), the focusing lens (3) is configured to focus the annular laser beam to form a light spot (10), and the light-spot adjustment device (8) is configured to move the first reflection beam splitter (1) to adjust a diameter of the light spot (10).

14. The double-mirror focusing inside-beam powder-feeding laser-cladding device according to claim 13, wherein the laser output device (7) is configured to connect to a transmission fiber to output the laser beam (11).

15. The double-mirror focusing inside-beam powder-feeding laser-cladding device according to claim 13, further comprising: a protective mirror (4), wherein the protective mirror (4) is disposed at two sides of the vertical piping powder feeding device (5) and disposed at a side of the focusing lens (3) facing away from the light-spot adjustment device (8).

16. The double-mirror focusing inside-beam powder-feeding laser-cladding device according to claim 13, wherein the first reflection beam splitter (1) and the second reflection beam splitter (2) are configured to shift the collimated beam outwards in parallel or at an angle relative to the central axis (9).

17. The double-mirror focusing inside-beam powder-feeding laser-cladding device according to claim 13, further comprising: a plane mirror (12) disposed between the second reflection beam splitter (2) and the focusing lens (3); and
wherein the plane mirror (12) is configured to reflect the annular laser beam with a deflection angle of 0-90 degrees to obtain a reflected annular laser beam, and then the reflected annular laser beam is focused by the focusing lens (3).

18. The double-mirror focusing inside-beam powder-feeding laser-cladding device according to claim 13, wherein the light-spot adjustment device (8) comprises: a base (81), a lifting base (82), and a plurality of wedges (83);
wherein the base (81) is provided with a concave V-shaped surface thereon, the lifting base (82) is provided with a convex V-shaped surface, and the lifting base (82) is disposed on the base (81) through matching the convex V-shaped surface of the lifting base (82) with the concave V-shaped surface of the base (81); and
wherein each of two opposite sides of the base (81) defines two sliding grooves (811), and the plurality of wedges (83) are disposed in the sliding grooves (811) defined on the two opposite sides of the base (81) respectively, and each of the two opposite sides of the base (81) defines a threaded hole (812) disposed between the two sliding grooves (811); and a connecting plate (86) is provided between the wedges (83) disposed in the two sliding grooves (811) on each side of the base, and bolted to the base (81) through the threaded hole (812).

19. The double-mirror focusing inside-beam powder-feeding laser-cladding device according to claim 18, wherein a side of the base (81) facing towards the lifting base and a side of the lifting base (82) facing towards the base (81) are symmetrically provided with a plurality of pairs of blind holes (87) respectively, and the plurality of springs (85) are disposed in the plurality of pairs of blind holes (87) correspondingly.

20. A double-mirror focusing inside-beam powder-feeding laser-cladding device, comprising:
a laser output device (7), configured to output a laser beam (11);
a collimated lens group (6), disposed at a side of the laser output device (7), and configured to collimate the laser beam (11) to output a collimated beam;
a first reflection beam splitter (1), disposed at a side of the collimated lens group (6) facing away from the laser output device (7);
a second reflection beam splitter (2), disposed outside the first reflection beam splitter (1), wherein the first reflection beam splitter (1) and the second reflection beam splitter (2) are configured to reflect the collimated beam to obtain an annular laser beam;
a focusing lens (3), disposed at a side of the first reflection beam splitter (1) facing away from the collimated lens group (6) and configured to focus the annular laser beam to form a light spot; and
a vertical piping powder feeding device (5), disposed at a side of the first reflection beam splitter (1) facing away from the collimated lens group (6);
wherein the focusing lens (3) is disposed outside the vertical piping powder feeding device (5).
